(19) United States
(12) Patent Application Publication
(10) Pub. No.: US 2014/0127561 A1
(43) Pub. Date: May 8, 2014

(54) NON-AQUEOUS ELECTROLYTE SECONDARY BATTERY

(71) Applicant: Sanyo Electric Co., Ltd., Osaka (JP)

(72) Inventors: Shinichi Yamami, Kasai City (JP); Toshikazu Yoshida, Kasai City (JP); Toyoki Fujihara, Kanzaki-gun (JP); Toshiyuki Nohma, Kobe City (JP)

(21) Appl. No.: 13/942,935

(22) Filed: Jul. 16, 2013

(30) Foreign Application Priority Data
Aug. 9, 2012 (JP) 2012-177187

(51) Int. Cl. H01M 10/0567; H01M 10/052

(52) U.S. Cl. CPC H01M 10/0567; H01M 10/052
USPC 429/188

(57) ABSTRACT

To provide a high-capacity non-aqueous electrolyte secondary battery with superior output characteristics and durability.

The present invention is a non-aqueous electrolyte secondary battery including a negative electrode and a non-aqueous electrolyte, the non-aqueous electrolyte secondary battery characterized in that the non-aqueous electrolyte includes lithium bis(oxalato)borate, the negative electrode has a negative electrode core and a negative electrode active material layer formed on the negative electrode core, and the negative electrode active material is graphite particles having a D90/D10 ratio of three or more, D10 being the 10% particle size and D90 being the 90% particle size in a cumulative particle size distribution of the volume standard of the graphite particles.

### CROSS-REFERENCE TO RELATED APPLICATIONS

This application claims the benefit of Japanese Patent Application No. 2012-177187 filed Aug. 9, 2012, the disclosure of which is herein incorporated by reference in its entirety.

### FIELD OF THE INVENTION

The present invention relates to a non-aqueous electrolyte secondary battery and, more specifically, to an improvement in the battery characteristics of a non-aqueous electrolyte secondary battery.

### BACKGROUND

Battery-powered vehicles with a secondary battery power supply, such as electric vehicles (EV) and hybrid electric vehicles (HEV), are becoming increasingly popular. However, these battery-powered vehicles require high-output/high-capacity secondary batteries.

Non-aqueous electrolyte secondary batteries, such as lithium ion secondary batteries, have a high energy density and a high capacity. The positive electrode and negative electrodes have an active material layer provided on both sides of the electrode core, and the positive electrode and negative electrode are wound together or laminated on each other via a separator to form an electrode assembly. This electrode assembly increases the opposing surface area between the positive and negative electrodes, and facilitates the extraction of a large current.

As a result, non-aqueous electrolyte secondary batteries using a wound or laminated electrode assembly are used for this purpose.

In Patent Document 1, a technology related to a collector structure for stably extracting current from a high-output battery has been proposed.

### PRIOR ART DOCUMENTS

### Patent Documents

Patent Document 1 Published Unexamined Patent Application No. 2010-086780

The technology disclosed in Patent Document 1 is a rectangular secondary battery in which a first current collecting plate is arranged in a first electrode core collecting area from which first electrode cores laminated directly on top of each other protrude. The first current collecting plate is resistance-welded on a surface parallel to the plane on which the first electrode cores are laminated. In this secondary battery, a first electrode core melt-attachment portion to which the first electrode cores are melt-attached is formed in an area separate from the area in which the first current collecting plate is attached.

### SUMMARY

### Problem Solved by the Invention

In addition to a better collector structure, vehicle-mounted batteries also require improved output characteristics as well as improved durability, such as storage characteristics and cycle characteristics. However, these points are not considered in Patent Document 1.

In view of this situation, an object of the present invention is to provide a non-aqueous electrolyte secondary battery having superior battery characteristics and durability.

### Means of Solving the Problem

In order to solve this problem, the present invention is a non-aqueous electrolyte secondary battery including a negative electrode and a non-aqueous electrolyte, the non-aqueous electrolyte secondary battery characterized in that the non-aqueous electrolyte includes lithium bis(oxalato)borate (LiB(C₂O₄)₂), the negative electrode has a negative electrode core and a negative electrode active material layer formed on the negative electrode core, and the negative electrode active material is graphite particles having a D90/D10 ratio of three or more, D10 being the 10% particle size and D90 being the 90% particle size in a cumulative particle size distribution of the volume standard of the graphite particles.

Because there is a D90/D10 ratio of three or more in the cumulative particle size distribution of the volume standard for the graphite particles included in the negative electrode active material, the particle distribution for the graphite particles is broad, and particles having a relatively large particle diameter coexist with particles having a relatively small particle diameter. Because the particles with a relatively small particle diameter fill in the crevices of the particles with a relatively large particle diameter, the number of contact points between graphite particles increases, and a good electron-conducting network is formed in the entire negative electrode active material layer. As a result, the charging/discharging reactions proceed quickly in the entire negative electrode active material layer, and the input/output characteristics of the battery are improved.

Because the charging/discharging reactions proceed quickly in the entire negative electrode active material layer, the potential of the negative electrode active material layer is uniform, and the protective film derived from the lithium bis(oxalato)borate contained in the non-aqueous electrolyte is formed uniformly on the surface of the negative electrode active material. In this way, the durability of the battery can be improved, especially the storage characteristics and cycle characteristics.

This non-aqueous electrolyte secondary battery can be configured so that D50 is from 10 to 20 μm, where D50 is the 50% particle size in a cumulative particle size distribution of the volume standard of the graphite particles. When graphite particles with a D90/D10 ratio of three or more are used in which the particle distribution has a D50 from 10 to 20 μm, the charge/discharge efficiency of the negative electrode active material remains good and a good electron-conducting network can be formed in the negative electrode active material layer.

The cumulative particle distribution which is the volume standard of the graphite particles can be measured using the laser diffraction particle size distribution measuring method (wet). Here, the 10% particle diameter D10, the 50% particle diameter D50 and the 90% particle diameter D90 are the particle diameters D (μm) when the Q % is 10%, 50% and 90% on the cumulative distribution curve, where the horizontal axis is the grain diameter D (μm) and the vertical axis is the volume Q (%) of the particles at the particle diameter D (μm).

The D90/D10 ratio is preferably six or less. When the D90/D10 ratio is greater than six, the large graphite particles tend to clock the mesh during the production of the slurry.

Graphite particles with a D90/D10 ratio of three or more can be prepared, for example, by changing the pulverizing and classifying conditions for the graphite material to obtain two or more types of graphite powder with different particle distributions, and then mixing the graphite powders together.

The packing density of the negative electrode active material layer is preferably from 1.0 to 1.6 g/ml. Because the packing density of the negative electrode active material layer is within this range, a good electron-conducting network can be formed in the entire negative electrode active material layer. When the packing density is too high, it takes too much time for the non-aqueous electrolyte to penetrate into the negative electrode active material layer, and productivity declines. When the packing density is too low, sufficient capacity is difficult to obtain.

This non-aqueous electrolyte secondary battery may be configured so that the non-aqueous electrolyte contains from 0.06 to 0.18 mol/L lithium bis(oxalato)borate. When the non-aqueous electrolyte contains less lithium bis(oxalato)borate, the effect is insufficient. When more lithium bis(oxalato)borate is added, the upper limit on effectiveness is exceeded and the additional amount is not cost effective.

The preferred range for the amount of lithium bis(oxalato)borate is determined based on the non-aqueous electrolyte in the non-aqueous electrolyte secondary battery after assembly and before the first charge. The range is determined in this manner because the amount gradually decreases as the non-aqueous electrolyte battery containing lithium bis(oxalato)borate is charged.

This non-aqueous electrolyte secondary battery may be configured so that the battery capacity is 5 Ah or greater. By applying the present invention to a high-capacity battery, the input/output characteristics and durability of the large-capacity battery can be further improved.

Here, the battery capacity is the discharge capacity (initial capacity) when the battery has been charged to a battery voltage of 4.1 V using 5 A of constant current, charged for 1.5 hours at a constant voltage of 4.1 V, and then discharged after charging to a battery voltage of 2.5 V at a constant current of 5 A. The charging and discharging was performed entirely at 25° C.

### Effect of the Invention

The present invention is able to provide a high-capacity non-aqueous electrolyte secondary battery having superior input/output characteristics and durability.

### BRIEF DESCRIPTION OF THE DRAWINGS

FIG. 1 is a perspective view of a non-aqueous electrolyte secondary battery according to the present invention.

FIG. 2 is a diagram showing the electrode assembly used in a non-aqueous electrolyte secondary battery according to the present invention.

FIGS. 3A-3B are plan views showing the positive and negative electrodes used in a non-aqueous electrolyte secondary battery according to a first embodiment respectively.

### DETAILED DESCRIPTION

### Embodiment 1

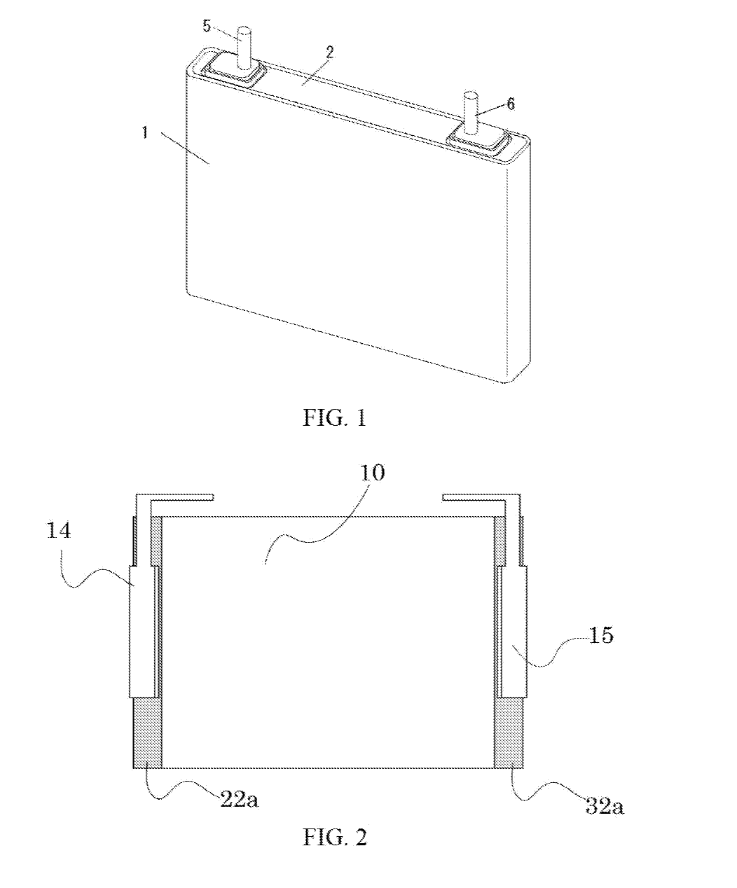

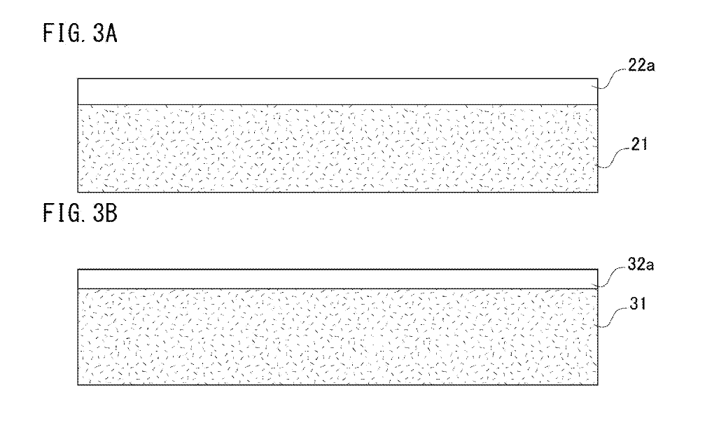

The following is an explanation with reference to the drawings of the battery of the present invention as applied to a lithium ion secondary battery. FIG. 1 is a perspective view of a non-aqueous electrolyte secondary battery according to the present invention, FIG. 2 is a diagram showing the electrode assembly used in a non-aqueous electrolyte secondary battery according to the present invention, and FIG. 3A-3B are plan views showing the positive and negative electrodes used in a non-aqueous electrolyte secondary battery according to a first embodiment respectively.

As shown in FIG. 1, a lithium ion secondary battery of the present invention has a rectangular outer can 1 with an opening, a sealing plate 2 for sealing the opening in the outer can 1, and positive and negative electrode terminals 5, 6 protruding outward from the sealing plate 2.

Also, as shown in FIG. 3A, the positive electrode 20 in the electrode assembly has a positive electrode core exposing portion 22a exposed on at least one end in the longitudinal direction of the band-shaped positive electrode core, and a positive electrode active material layer 21 formed on the positive electrode core. As shown in FIG. 3B, the negative electrode 30 has a first negative core exposing portion 32a exposed on at least one end in the longitudinal direction of the band-shaped negative electrode core, and a negative electrode active material layer 31 formed on the negative electrode core.

In the electrode assembly 10, the positive electrode and the negative electrode are wound together via an interposed separator which is a microporous polyethylene membrane. As shown in FIG. 2, the positive electrode core exposing portion 22a protrudes from one end of the electrode assembly 10, the negative electrode core exposing portion 32a protrudes from the other end of the electrode assembly 10, the positive electrode collector 14 is mounted on the positive electrode core exposing portion 22a, and the negative electrode collector 15 is mounted on the negative electrode core exposing portion 32a.

This electrode assembly 10 is housed inside the outer can 1 along with the non-aqueous electrolyte, and the positive electrode collector 14 and the negative electrode collector 15 are connected electrically to external electrodes 5, 6 protruding from the sealing plate 2 while being insulated from the sealing plate 2 to extract current.

Because the negative electrode active material in the negative electrode active material layer 31 includes graphite particles, and because there is a D90/D10 ratio of three or more for D90 and D10 in the cumulative particle size distribution, particles having a relatively large particle diameter coexist with particles having a relatively small particle diameter. Because the particles with a relatively small particle diameter fill in the crevices of the particles with a relatively large particle diameter, the number of contact points between graphite particles increases, and a good electron-conducting network is formed in the entire negative electrode active material layer. As a result, the charging/discharging reactions proceed quickly in the entire negative electrode active material layer, and the input/output characteristics of the battery are improved. The 50% particle size D50 of the graphite particles is preferably from 10 to 20 μm.

The non-aqueous electrolyte includes a non-aqueous solvent and an electrolyte salt dissolved in the solvent. Lithium bis(oxalato)borate is added to the non-aqueous electrolyte, and the negative electrode active material layer 31 is impregnated with the non-aqueous electrolyte. Because, as mentioned above, the charging/discharging reactions proceed quickly in the entire negative electrode active material layer, the potential of the negative electrode active material layer is uniform, and the protective film derived from the lithium bis(oxalato)borate contained in the non-aqueous electrolyte is formed uniformly on the surface of the negative electrode active material. In this way, the durability of the battery can be improved, especially the storage characteristics and cycle characteristics. The amount of lithium bis(oxalato)borate in the non-aqueous electrolyte is preferably from 0.06 to 0.18 mol/L.

Embodiment of the present invention will now be explained with reference to examples. The present invention is not limited to the following embodiment, and may be modified where appropriate within the spirit and scope of the invention.

### EXAMPLES

In the following example, the non-aqueous electrolyte secondary battery shown in FIG. 1 through FIG. 3B was prepared.

### Example 1

### Preparation of Positive Electrode

A lithium-transition metal composite oxide (LiNi_{0.35}Co_{0.35}Mn_{0.3}O₂) serving as the positive electrode active material, flaky graphite and carbon black serving as the conductive agents, and N-methylpyrrolidone (NMP) solution of polyvinylidene fluoride serving as the bonding agent were kneaded together to obtain a positive electrode active material slurry with a lithium-transition metal composite oxide flaky graphite:carbon black:polyvinylidene fluoride solid mass ratio of 88:7:2:3.

After applying the positive electrode active material slurry to both sides of aluminum alloy foil serving as the positive electrode core (thickness: 15 μm), the slurry was dried to remove the NMP used as the solvent in slurry preparation and to form positive electrode active material layers on the positive electrode core. This was then rolled using a mill roll and cut to predetermined dimensions to complete the positive electrode 20. A positive electrode core exposing portion 22a was provided in the positive electrode 20 to expose the core in the longitudinal direction of the positive electrode core for connection to the positive electrode collector.

### Preparation of Negative Electrode

Natural graphite fashioned into round graphite particles, pitch and carbon black were mixed together to coat the surface of the round graphite particles with pitch and carbon black. The mass ratio of round graphite particles to pitch to carbon black in the mixture was 100:5:5 at this time.

Next, coated graphite particles were obtained by baking the resulting compound for 24 hours at 900-1500° C. in an inactive gas atmosphere, pulverizing the baked compound, and coating the surface of the graphite particles with a coating layer containing amorphous carbon particles and an amorphous carbon layer. At this time, the conditions were changed while pulverizing the baked compound to prepare three types of graphite powder with different particle distributions. The three types of graphite powder were then mixed together to complete the negative electrode active material. When the particle distribution of the mixed graphite particles in the negative electrode active material was measured using a laser diffraction-type particle size distribution measuring device (Seishin Enterprise LMS-30), the D90/D10 ratio was 4.18, and D10, D50 and D90 were 6.52 μm, 13.17 μm and 27.27 μm.

A negative electrode active material slurry was prepared by kneading together the negative electrode active material obtained above, a carboxymethylcellulose (CMC) thickener, a styrene-butadiene rubber (SBR) bonding agent, and water. The mass ratio of the coated graphite, the CMC and the SBR at this time was 98.9:0.7:0.4.

After applying the negative electrode active material slurry to the copper foil serving as the negative electrode core (thickness: 10 μm), the slurry was dried to remove the water used as the solvent in slurry preparation and to form negative electrode active material layers on the negative electrode core. This was then rolled using a mill roll to obtain a predetermined packing density (1.1 g/ml), and cut to predetermined dimensions to complete the negative electrode 30. A negative electrode core exposing portion 32a was provided in the negative electrode 30 to expose the core in the longitudinal direction of the negative electrode core for connection to the negative electrode collector.

The packing density of the negative electrode active material layer was determined in the following manner. First, the negative electrode was cut to 10 cm², and the mass A (g) of the cut 10 cm² negative electrode and the thickness C (cm) of the negative electrode were measured. Next, the mass B (g) of the 10 cm² core and the thickness D (cm) of the core were measured. Finally, the packing density was determined using the following equation:

Packing Density=(A−B)/[(C−D)×10 cm²]

The packing density of the negative electrode active material layer can be controlled, for example, by adjusting the pressure when the negative electrode active material layer is rolled.

### Preparation of Electrode Assembly

The positive electrode, the negative electrode and a polyethylene microporous membrane separator (thickness: 30 μm) were laid on top of each other so that the positive electrode core exposing portion 22a and the negative electrode core exposing portion 32a protruded from the three layers in opposite directions relative to the winding direction, and so that the separator was interposed between the different active material layers. The layers were then wound together using a winding machine, insulated tape was applied to prevent unwinding, and the resulting electrode assembly was flattened using a press.

### Connecting the Collectors to the Sealing Plate

An aluminum positive electrode collector 14 and a copper negative electrode collector 15 with two protrusions (not shown) on the same surface were prepared, and two aluminum positive electrode collector receiving components (not shown) and two copper negative electrode collector receiving components (not shown) with one protrusion on one surface were also prepared. Insulating tape was applied to enclose the protrusions of the positive electrode collector 14, negative electrode collector 15, positive electrode collector receiving components and negative electrode collector receiving components.

A gasket (not shown) was arranged on the inside surface of a through-hole (not shown) provided in the sealing plate 2, and on the outside surface of the battery surrounding the through-hole, and an insulating component (not shown) was arranged on the inside surface of the battery surrounding the through-hole provided in the sealing plate 2. The positive electrode collector 14 was positioned on top of the insulating component on the inside surface of the sealing plate 2 so that the through-hole in the sealing plate 2 was aligned with the through-hole (not shown) in the collector. Afterwards, the inserted portion of a negative electrode terminal 5 having a flange portion (not shown) and an inserted portion (not shown) was inserted from outside the battery into the through-hole in the sealing plate 2 and the through-hole of the collector. The diameter of the lower end of the inserted portion (inside the battery) is then widened, and the positive electrode collector 14 and the positive electrode terminal 5 were caulked to the sealing plate 2.

The negative electrode collector 15 and the negative electrode terminal 6 were caulked to the sealing plate 2 in the same way on the negative electrode side. In this operation, the various components were integrated, and the positive and negative electrode collectors 14, 15 and the positive and negative electrode terminals 5, 6 were connected conductively. In this structure, the positive and negative electrode terminals 5, 6 protruded from the sealing plate 2 while remaining insulated from the sealing plate 2.

### Mounting of Collector

The positive electrode collector 14 was arranged on the side of the flat electrode assembly with the core exposing portion of the positive electrode 11 so that the protrusion was on the side with the positive electrode core exposing portion 22a. One of the positive electrode collector receiving components is brought into contact with the positive electrode core exposing portion 22a so that the protrusion on the positive electrode collector receiving component is on the positive electrode core exposing portion 22a side, and so that one of the protrusions on the positive electrode collector 14 is facing the protrusion on the positive electrode collector receiving component. Next, a pair of welding electrodes is pressed against the back of the protrusion on the positive electrode collector 14 and on the back of the positive electrode collector receiving component, current flows through the pair of welding electrodes, and the positive electrode collector 14 and the positive electrode collector receiving component are resistance-welded to the positive electrode core exposing portion 22a.

Afterwards, the other positive electrode collector receiving portion is brought into contact with the positive electrode core exposing portion 22a so that the protrusion on the positive electrode collector receiving portion is on the positive electrode core exposing portion 22a side, and so that the other protrusion on the positive electrode collector 14 is facing the protrusion on the positive electrode collector receiving component. Next, the pair of welding electrodes is pressed against the back of the protrusion on the positive electrode collector 14 and on the back of the positive electrode collector receiving component, current flows through the pair of welding electrodes, and the positive electrode collector 14 and the positive electrode collector receiving component are resistance-welded a second time to the positive electrode core exposing portion 22a.

In the case of the negative electrode 30, the negative electrode collector 15 and the negative electrode collector receiving components are resistance-welded to the first negative electrode core exposing portion 32a in the same way.

### Preparation of Non-Aqueous Electrolyte

Ethylene carbonate, which is a cyclic carbonate, and ethyl methyl carbonate, which is a linear carbonate, were mixed together at a volume ratio of 3:7 (1 atm, 25° C.), and a lithium hexafluorophosphate (LiPF₆) electrolyte salt was dissolved in the resulting mixed solvent at a ratio of 1 mol/L. To the resulting solution were added vinylene carbonate at a concentration of 0.3 mass %, and lithium bis(oxalato)borate at a concentration of 0.12 mol/L to complete the non-aqueous electrolyte.

### Assembly of Battery

The electrode assembly 10 integrated with the sealing plate 2 was inserted into the outer can 1, the sealing plate 2 was fitted into the opening in the outer can 1, the welded portion of the outer can 1 was laser-welded around the sealing plate 2, a predetermined amount of non-aqueous electrolyte was poured in via a non-aqueous electrolyte hole (not shown) in the sealing plate 2, the non-aqueous electrolyte hole was sealed, and the non-aqueous electrolyte secondary battery in the first example was complete.

### Comparative Example 1

Coated graphite particles with a D90/D10 ratio of 2.63 were obtained in the same manner as the first example, by obtaining, pulverizing and classifying baked graphite. The non-aqueous electrolyte secondary battery of the first comparative example was prepared in the same manner as the first example except that the coated graphite particles were used as the negative electrode material. The D10, D50 and D90 of the coated particles used in the first comparative example were 7.54 μm, 11.99 μm and 19.83 μm.

### Measurement of Battery Capacity

The battery capacities of the batteries in the first example and the first comparative example were measured in the following manner. The batteries were charged at a constant current of 5 A to a battery voltage of 4.1 V, and then charged for 1.5 hours at a constant current of 4.1 V. After charging, the batteries were discharged at a constant current of 5 A to a battery voltage of 2.5 V. The discharge capacity at this time was the battery capacity. As a result, the battery capacity of the battery in the first example was 5.60 Ah, and the battery capacity of the battery in the first comparative example was 5.56 Ah.

### Evaluation

### Room Temperature IV Measurement (Output)

The batteries in the first example and first comparative example were charged at 25° C. and at a constant current of 5 A to a state of charge (SOC) of 50%. Afterwards, the batteries were discharged for ten seconds each at constant currents of 5 C, 10 C, 18 C, 24 C, 30 C, 36 C and 42 C. The battery voltages were measured, each current value and battery voltage was plotted, and the room temperature output voltage was determined (voltage W during a 2.7 V discharge). The results are shown in Table 1.

### Room Temperature IV Measurement (Regeneration)

The batteries in the first example and first comparative example were charged at 25° C. and at a constant current of 5 A to a state of charge (SOC) of 50%. Afterwards, the batteries were charged for ten seconds each at constant currents of 5 C, 10 C, 18 C, 24 C, 30 C, 36 C and 42 C. The battery voltages were measured, each current value and battery voltage was plotted, and the room temperature output regeneration was determined (voltage W during a 4.2 V charge). The results are shown in Table 1.

In Table 1, the room temperature output values and room temperature regeneration values are relative values. Here, the values for the battery in the first comparative example are 100.

TABLE 1

| | | Room Temperature | Room Temperature |
|---|---|---|---|
| | D90/D10 Ratio | Output (%) | Regeneration (%) |
| Example 1 | 4.18 | 103 | 101 |
| | (Broad Particle | | |
| | Distribution) | | |
| Comparative | 2.63 | 100 | 100 |
| Example 1 | (Sharp Particle | | |
| | Distribution) | | |

Discharge Capacity after Storage

The batteries in the first example and the first comparative example were charged to an SOC of 80% using a constant current of 5 A. After charging, the batteries were stored for 56 days at 70° C. After storage, the batteries were discharged at 25° C. to a battery voltage of 2.5 V at a constant current of 5 A. The results are shown in Table 2.

Capacity Retention Rate after Storage

After measuring the discharge capacity after storage, the batteries in the first example and the first comparative example were charged to a battery voltage of 4.1 V at a constant current of 5 A, and the charged batteries were discharged to a battery voltage of 2.5 V at a constant current of 5 A. The measured discharge capacity was the discharge capacity after charging and discharging. The capacity retention rate after storage was then calculated using the following equation:

Capacity Retention Rate After Storage (%)=Discharge Capacity After Charge, Storage and Discharge (Ah)/Battery Capacity (Ah)×100.

The results are shown in Table 2.

In Table 2, the values for the discharge capacity after storage and the capacity retention rate after storage of the battery in the first example are relative values. Here, the values for the battery in the first comparative example are 100.

TABLE 2

| | | Discharge Capacity | Discharge Retention |
|---|---|---|---|
| | D90/D10 Ratio | After Storage (%) | Rate After Storage |
| Example 1 | 4.18 | 104 | 103 |
| | (Broad Particle | | |
| | Distribution) | | |
| Comparative | 2.63 | 100 | 100 |
| Example 1 | (Sharp Particle | | |
| | Distribution) | | |

It is clear from Table 1 that the room temperature output value and room temperature regeneration value of the battery in the first example, in which the non-aqueous electrolyte contained lithium bis(oxalato)borate, and in which the D90/D10 ratio for D90 and D10 in the cumulative particle distribution of the negative electrode active material particles was three or more, were improved to 103% and 101%, which are values relative to the battery in the first comparative example. Because the particle distribution for the graphite particles in the negative electrode active material of the first example is broad, particles having a relatively large particle diameter coexist with particles having a relatively small particle diameter. Because the particles with a relatively small particle diameter fill in the crevices of the particles with a relatively large particle diameter, the number of contact points between graphite particles increases, and a good electron-conducting network is formed in the entire negative electrode active material layer. As a result, the charging/discharging reactions proceed quickly in the entire negative electrode active material layer, and the room temperature output and room temperature regeneration are improved.

Also, it is clear from Table 2 that the discharge capacity after storage and the capacity retention rate of the battery in the first example have improved to 104% and 103%, which are values relative to the battery in the first comparative example. In other words, the durability was improved. Because the charging/discharging reactions proceed quickly in the entire negative electrode active material layer, the potential of the negative electrode active material layer is uniform, and the protective film derived from the lithium bis(oxalato)borate contained in the non-aqueous electrolyte is formed uniformly on the surface of the negative electrode active material. This is believed to suppress reductive decomposition of the non-aqueous electrolyte and self-discharge due to reductive decomposition, and thus improve the discharge capacity after storage and the capacity retention rate of the battery.

### Additional Details

The positive electrode active material can be one or more of the following: a lithium-containing nickel-cobalt-manganese composite oxide (LiNiₓCo_{y}Mn_{z}O₂, x+y+z=1, 0≦x≦1, 0≦y≦1, 0≦z≦1), a lithium-containing cobalt composite oxide (LiCoO₂), lithium-containing nickel composite oxide (LiNiO₂), a lithium-containing nickel-cobalt composite oxide (LiCoₓNi₁₋ₓO₂), a lithium-containing manganese composite oxide (LiMnO₂), spinel-type lithium manganese oxide (LiMn₂O₄), or a lithium-containing transition metal composite oxide in which some of the transition metal in the oxide has been substituted by another element (for example, Ti, Zr, Mg, Al, etc.).

In addition to lithium bis(oxalato)borate, one or more other lithium salts (base electrolyte salts) can be used as electrolyte salts. Examples include LiPF₆, LiBF₄, LiCF₃SO₃, LiN(CF₃SO₂)₂, LiN(C₂F₅SO₂)₂, LiN(CF₃SO₂)(C₄F₉SO₂)₂, LiC(C₂F₅SO₂)₃, LiAsF₆, LiClO₄, Li₂B₁₀Cl₁₀, Li₂B₁₂I₁₂, LiB(C₂O₄)F₂, and LiP(C₂O₄)₂F₂. The total concentration of electrolyte salts in the non-aqueous electrolyte is preferably from 0.5 to 2.0 mol/L.

The non-aqueous solvent can be one or more of the following: a high dielectric constant solvent in which lithium salts are highly soluble including a cyclic carbonate, such as ethylene carbonate, propylene carbonate, butylene carbonate or fluoroethylene carbonate, or a lactone such as γ-butyrolactone or γ-valerolactone; a linear carbonate, such as diethyl carbonate, dimethyl carbonate or ethyl methyl carbonate; or a low viscosity solvent including an ether, such as tetrahydrofuran, 1,2-dimethoxyethane, diethylene glycol dimethylethane, 1,3-dioxolane, 2-methoxytetrahydrofuran or diethyl ether; or a carboxylic acid ester, such as ethyl acetate, propyl acetate or ethyl propionate. A mixed solvent including two or more types of high dielectric constant solvent and low viscosity solvent can also be used.

Any well-known additive, such as vinylene carbonate, cyclohexyl benzene, and tert-amyl benzene can be added to the non-aqueous electrolyte.

A microporous membrane or membrane laminate of an olefin resin, such as polyethylene, polypropylene or a mixture thereof, can be used as the separator.

### INDUSTRIAL APPLICABILITY

As explained above, the present invention can provide a high-capacity non-aqueous electrolyte secondary battery having excellent output/regeneration properties and durability. Thus, industrial applicability is great.

### KEY TO THE DRAWINGS

1: Outer Can
2: Sealing Plate
5, 6: Electrode Terminals
10: Electrode Assembly
14: Positive Electrode Collector
15: Negative Electrode Collector
20: Positive Electrode
21: Positive Electrode Active Material Layer
22a: Positive Electrode Core Exposing Portion
30: Negative Electrode
31: Negative Electrode Active Material Layer
32a: Negative Electrode Core Exposing Portion

What is claimed is:

1. A non-aqueous electrolyte secondary battery including a negative electrode and a non-aqueous electrolyte, the non-aqueous electrolyte secondary battery characterized in that the non-aqueous electrolyte includes lithium bis(oxalato)borate, the negative electrode has a negative electrode core and a negative electrode active material layer formed on the negative electrode core, and the negative electrode active material is graphite particles having a D90/D10 ratio of three or more, D10 being the 10% particle size and D90 being the 90% particle size in a cumulative particle size distribution of the volume standard of the graphite particles.

2. The non-aqueous electrolyte secondary battery according to claim 1, wherein D50 is from 10 to 20 μm, D50 being the 50% particle size in a cumulative particle size distribution of the volume standard of the graphite particles.

3. The non-aqueous electrolyte secondary battery according to claim 1, wherein the concentration of lithium bis(oxalato)borate is from 0.06 to 0.18 mol/L.

4. The non-aqueous electrolyte secondary battery according to claim 1, wherein the battery capacity of the non-aqueous electrolyte secondary battery is equal to or greater than 5 Ah.
